(19) United States
(12) Patent Application Publication
(10) Pub. No.: US 2010/0206812 A1
(43) Pub. Date: Aug. 19, 2010

(54) HIGH EFFICIENCY SEPARATIONS METHOD AND APPARATUS

(75) Inventors: Richard Rood Woods, Irvine, CA (US); Vahik Krikorian, La Canada, CA (US); Juston Smithers, Los Angeles, CA (US)

Correspondence Address: Joseph M Kobzeff, P.O.Box 50502, Irvine, CA, 92619, US

(73) Assignee: PRIMAFUEL, INC, Signal Hill, CA (US)

(21) Appl. No.: 12/708,491

(22) Filed: Feb. 18, 2010

Related U.S. Application Data
(60) Provisional application No. 61/153,919, filed on Feb. 19, 2009.

(51) Int. Cl. B01D 17/12; B01D 15/08; B01D 3/00

(52) U.S. Cl. 210/656; 210/177

(57) ABSTRACT

The invention concerns separation methods and systems comprising a continuous chromatographic simulated moving bed integrated with vapor compression distillation to create a high efficiency separations platform applicable to a broad range of separation functions.

This application claims the benefit under 35 USC §119(e) of U.S. Provisional Application No. 61/153,919, filed on Feb. 19, 2009; the disclosure of which is hereby expressly incorporated by reference in its entirety and is hereby expressly made a portion of this application.

### FIELD OF THE INVENTION

Methods for separation of chemicals in the liquid and gaseous state are provided, which can be applied to the processing of biofuels.

### BACKGROUND OF THE INVENTION

In the evolving biofuels industry much of the conventional process and refining equipment and many of the techniques are being applied to new feedstock for producing renewable fuels. Unlike the petroleum industry where economies of scale drove refineries to larger and larger facilities, the typical lower energy density of biofuels and dispersed agriculture nature of the feedstock result in bio-refineries that are typically smaller, more compact facilities appropriately scaled to the nearby feedstock. Corn ethanol facilities and biodiesel refineries are finding economic implementations in facilities from 10 million gallons to 100 million gallons of biofuels per year. As a result, the economics of byproduct processing, such as glycerin refining in a biodiesel facility or refining crude corn oil extracted from an ethanol facility, requires the application of advanced technologies which are economical at low capacities using small-scale equipment.

### SUMMARY OF THE INVENTION

The increasing concern with global climate change and the increasing concentration of carbon dioxide in the atmosphere are driving biorefineries to greater energy efficiencies to reduce the carbon footprint of the refining processes.

What is needed are high efficiency bio-refinery and co-product extraction and purification processes that provide improved economics and lower energy consumption in small-scale equipment with broad application to the evolving bio-refinery industry.

Systems and methods of separating mixtures of compounds, where at least one compound is heat sensitive or where there is a tendency to form solids capable of forming a precipitate or scale that interferes with the operation of the separation system are desirable.

Accordingly, in a first aspect, a process is provided for separation and purification of compounds in a liquid mixture with low energy input comprising passing a feed mixture comprising a first compound and a second compound into a simulated moving bed chromatography apparatus; the first compound acting as a solvent for the second compound which forms a precipitate at concentrations above a solubility limit; passing an eluent solvent into the simulated moving bed chromatography apparatus to separate the feed into a first stream and a second stream, and optionally additional streams, wherein the first stream has an elevated concentration of the first compound in eluent and the second stream has an elevated concentration of the second compound, as compared to the feed; passing the first stream to a vapor compression distillation unit to generate a high purity stream of the first compound; vaporizing at least a portion of the eluent from the first stream at a first temperature to form a vapor, compressing the vapor to form an eluent condensate at a second temperature, such that the second temperature is greater than the first temperature, and the eluent condensate has a thermal energy content; and transferring at least a portion of the thermal energy content of the eluent condensate into the first stream to be used in vaporizing the eluent in the first stream.

In one embodiment of the first aspect, the first compound is present in the high purity stream of the first compound at a concentration of about 85% (wt.) or greater.

In one embodiment of the first aspect, the first compound is present in the high purity stream of the first compound at a concentration of about 90% (wt.) or greater.

In one embodiment of the first aspect, the first compound is present in the high purity stream of the first compound at a concentration of about 95% (wt.) or greater.

In one embodiment of the first aspect, the first compound is present in the high purity stream of the first compound at a concentration of about 98% (wt.) or greater.

In one embodiment of the first aspect, the first compound is present in the high purity stream of the first compound at a concentration of about 99% (wt.) or greater.

In one embodiment of the first aspect, less thermal energy is added to the process than would be needed to vaporize the high purity stream of the first compound.

In one embodiment of the first aspect, the process further comprises passing the second stream to a vapor compression distillation unit to recover additional eluent and to generate a concentrated second stream with less eluent.

In one embodiment of the first aspect, the process further comprises passing the second stream to a vapor compression distillation unit to recover additional eluent and to generate a concentrated second stream with less eluent, wherein the concentrated second stream has a concentration of eluent that is less than about one half an eluent concentration of the second stream.

In one embodiment of the first aspect, the process further comprises passing the second stream to a vapor compression distillation unit to recover additional eluent and to generate a concentrated second stream with less eluent, wherein the concentrated second stream has a concentration of eluent that is less than about one quarter an eluent concentration of the second stream.

In one embodiment of the first aspect, the process further comprises passing the second stream to a vapor compression distillation unit to recover additional eluent and to generate a concentrated second stream with less eluent, wherein the concentrated second stream has a concentration of eluent that is less than about one tenth of an eluent concentration of the second stream.

In one embodiment of the first aspect, the process further comprises passing the second stream to a vapor compression distillation unit to recover additional eluent and to generate a concentrated second stream with less eluent, wherein the concentrated second stream has a concentration of eluent that is less than about one twentieth of an eluent concentration of the second stream.

In a second aspect, a process is provided for separation and purification of compounds in a liquid mixture with low energy input comprising passing a feed mixture comprising a third compound and a fourth compound into a simulated moving bed chromatograph apparatus at a process temperature; the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound; passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound; passing the third stream to a vapor compression distillation unit to generate a high purity stream of the third compound; vaporizing the eluent from the third stream at a first temperature, compressing the vapor to form an eluent condensate at a second temperature such that the second temperature is greater than the first temperature, and the eluent condensate has a thermal energy content; and transferring at least a portion of the thermal energy content of the eluent condensate into the third stream to be used in vaporizing the eluent in the third stream.

In one embodiment of the second aspect, the third compound is present in the high purity stream of the first compound at a concentration of about 85% (wt.) or greater.

In one embodiment of the second aspect, the third compound is present in the high purity stream of the first compound at a concentration of about 90% (wt.) or greater.

In one embodiment of the second aspect, the third compound is present in the high purity stream of the first compound at a concentration of about 95% (wt.) or greater.

In one embodiment of the second aspect, the third compound is present in the high purity stream of the first compound at a concentration of about 98% (wt.) or greater.

In one embodiment of the second aspect, the third compound is present in the high purity stream of the first compound at a concentration of about 99% (wt.) or greater.

In one embodiment of the second aspect, a process is provided for separation and purification of compounds in a liquid mixture with low energy input comprising passing a feed mixture comprising a third compound and a fourth compound into a simulated moving bed chromatograph apparatus at a process temperature; the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound; passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound; passing the third stream to a vapor compression distillation unit to generate a high purity stream of the third compound; vaporizing the eluent from the third stream at a first temperature, compressing the vapor to form an eluent condensate at a second temperature such that the second temperature is greater than the first temperature; and transferring at least a portion of the thermal energy of the eluent condensate into the third stream to provide at least a portion of the energy needed to vaporize the eluent in the third stream, and less thermal energy is added to the process than would be needed to vaporize the high purity stream of the third compound.

In one embodiment of the second aspect, a process is provided for separation and purification of compounds in a liquid mixture with low energy input comprising passing a feed mixture comprising a third compound and a fourth compound into a simulated moving bed chromatograph apparatus at a process temperature; the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound; passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound; passing the third stream to a vapor compression distillation unit to generate a high purity stream of the third compound; vaporizing the eluent from the third stream at a first temperature, compressing the vapor to form an eluent condensate at a second temperature such that the second temperature is greater than the first temperature; transferring at least a portion of the thermal energy of the eluent condensate into the third stream to provide at least a portion of the energy needed to vaporize the eluent in the third stream; and passing the fourth stream to a vapor compression distillation unit to recover additional eluent and to generate a concentrated fourth stream.

In an embodiment of the second aspect, a process is provided for separation and purification of compounds in a liquid mixture with low energy input comprising passing a feed mixture comprising a third compound and a fourth compound into a simulated moving bed chromatograph apparatus at a process temperature; the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound; passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound; passing the third stream to a vapor compression distillation unit to generate a high purity stream of the third compound; vaporizing the eluent from the third stream at a first temperature, compressing the vapor to form an eluent condensate at a second temperature such that the second temperature is greater than the first temperature; transferring at least a portion of the thermal energy of the eluent condensate into the third stream to provide at least a portion of the energy needed to vaporize the eluent in the third stream; and passing the fourth stream to a vapor compression distillation unit to recover additional eluent and to generate a concentrated fourth stream, wherein the concentrated fourth stream has a concentration of eluent that is less than about one half an eluent concentration of the fourth stream.

In an embodiment of the second aspect, a process is provided for separation and purification of compounds in a liquid mixture with low energy input comprising passing a feed mixture comprising a third compound and a fourth compound into a simulated moving bed chromatograph apparatus at a process temperature; the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound; passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound; passing the third stream to a vapor compression distillation unit to generate a high purity stream of the third compound; vaporizing the eluent from the third stream at a first temperature, compressing the vapor to form an eluent condensate at a second temperature such that the second temperature is greater than the first temperature; transferring at least a portion of the thermal energy of the eluent condensate into the third stream to provide at least a portion of the energy needed to vaporize the eluent in the third stream; and passing the fourth stream to a vapor compression distillation unit to recover additional eluent and to generate a concentrated fourth stream, wherein the concentrated fourth stream has a concentration of eluent that is less than about one fourth an eluent concentration of the fourth stream.

In an embodiment of the second aspect, a process is provided for separation and purification of compounds in a liquid mixture with low energy input comprising passing a feed mixture comprising a third compound and a fourth compound into a simulated moving bed chromatograph apparatus at a process temperature; the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound; passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound; passing the third stream to a vapor compression distillation unit to generate a high purity stream of the third compound; vaporizing the eluent from the third stream at a first temperature, compressing the vapor to form an eluent condensate at a second temperature such that the second temperature is greater than the first temperature; transferring at least a portion of the thermal energy of the eluent condensate into the third stream to provide at least a portion of the energy needed to vaporize the eluent in the third stream; and passing the fourth stream to a vapor compression distillation unit to recover additional eluent and to generate a concentrated fourth stream, wherein the concentrated fourth stream has a concentration of eluent that is less than about one tenth an eluent concentration of the fourth stream.

In an embodiment of the second aspect, a process is provided for separation and purification of compounds in a liquid mixture with low energy input comprising passing a feed mixture comprising a third compound and a fourth compound into a simulated moving bed chromatograph apparatus at a process temperature; the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound; passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound; passing the third stream to a vapor compression distillation unit to generate a high purity stream of the third compound; vaporizing the eluent from the third stream at a first temperature, compressing the vapor to form an eluent condensate at a second temperature such that the second temperature is greater than the first temperature; transferring at least a portion of the thermal energy of the eluent condensate into the third stream to provide at least a portion of the energy needed to vaporize the eluent in the third stream; and passing the fourth stream to a vapor compression distillation unit to recover additional eluent and to generate a concentrated fourth stream, wherein the concentrated fourth stream has a concentration of eluent that is less than about one twentieth an eluent concentration of the fourth stream.

In a third aspect, a system is provided for separating two or more components from a process stream, the system comprising a simulated moving bed (SMB) subsystem with a mobile phase, the SMB subsystem configured to convert a feed stream comprising a first component and a second component, wherein the first component and the second component are present in the feed stream at a first ratio defined by the weight percent of the second component divided by the weight percent of the first component, and the first component is a solvent for the second component, and the second component forms a precipitate at a concentrations higher than a concentration present in the feed, into a first stream comprising at least a portion of the first component and at least a portion of the mobile phase, and a second stream comprising at least a portion of the second component and at least a portion of the mobile phase, wherein the first component and the second component are present in the first stream at a second ratio defined by the weight percent of the second component divided by the weight percent of the first component, wherein the first ratio is greater than the second ratio; and a vapor compression distillation subsystem, operating on a distillation feed stream comprising at least a portion of the first stream to separate an amount of the first component from at least a portion of the mobile phase that is present in the first stream with evaporation, the evaporation requiring a thermal energy input, and the system for separating two or more components from a process stream having a total thermal energy input, wherein the distillation feed stream is subjected to a maximum bulk temperature and a maximum surface temperature during processing in the vapor compression distillation subsystem, the total thermal energy input to the system being less than the thermal energy required to evaporate the amount of first component separated in the vapor compression distillation subsystem, and the second component does not form a precipitate in the distillation feed stream at a bulk temperature experienced by the portion of the first stream within the vapor compression distillation subsystem.

In an embodiment of the third aspect, the temperature experienced by the portion of the first stream is a bulk temperature.

In an embodiment of the third aspect, the temperature experienced by the portion of the first stream is the maximum bulk temperature.

In an embodiment of the third aspect, the temperature experienced by the portion of the first stream is the maximum bulk temperature, and the maximum bulk temperature is about 230° F. to about 260° F., or about 250° F. to about 280° F., or about 270° F. to about 300° F., or about 290° F. to about 320° F., or about 310° F. to about 340° F., or about 330° F. to about 360° F., or about 350° F. to about 400° F.

In an embodiment of the third aspect, the temperature experienced by the portion of the first stream is a surface temperature.

In an embodiment of the third aspect, the temperature experienced by the portion of the first stream is the maximum surface temperature.

In an embodiment of the third aspect, the temperature experienced by the portion of the first stream is the maximum surface temperature, and the maximum surface temperature is about 230° F. to about 260° F., or about 250° F. to about 280° F., or about 270° F. to about 300° F., or about 290° F. to about 320° F., or about 310° F. to about 340° F., or about 330° F. to about 360° F., or about 350° F. to about 400° F.

In a fourth aspect, a system is provided for separating two or more components from a process stream, the system comprising an SMB subsystem with a mobile phase, the SMB subsystem configured to convert a feed stream comprising a first component and a second component, wherein the first component and the second component are present in the feed stream at a first ratio defined by the weight percent of the second component divided by the weight percent of the first component, and at least one of the components is altered at a first temperature, the first temperature being lower than a temperature at which the other component is altered, and the alteration is not reversed completely upon cooling, into a first stream comprising at least a portion of the first component and at least a portion of the mobile phase, and a second stream comprising at least a portion of the second component and at least a portion of the mobile phase, wherein the first component and the second component are present in the first stream at a second ratio defined by the weight percent of the second component divided by the weight percent of the first component, wherein the first ratio is greater than the second ratio; and a vapor compression distillation subsystem, the vapor compression distillation subsystem operating on a distillation feed stream comprising at least a portion of the first stream to separate an amount of the first component from at least a portion of the mobile phase that is present in the first stream, the first component having a boiling point in its purified form at a second temperature at a pressure present within the vapor compression distillation subsystem, the second component having a boiling point in its purified form at a third temperature at a pressure present within the distillation subsystem, a portion of the mobile phase present in the distillation feed stream having a boiling point at a fourth temperature at a pressure present within the distillation subsystem, the fourth temperature being lower than the first temperature and the first temperature being lower than both the second and third temperatures, the vapor compression distillation subsystem having a first thermal energy requirement to be supplied to produce a mass of the first component, the first thermal energy requirement being less than an amount of thermal energy necessary to evaporate the mass of first component.

### BRIEF DESCRIPTION OF THE DRAWINGS

FIG. 1 illustrates the integration of the SMB, polishing bed, and vapor compression distillation (VCD) for removing the eluent from the extract or product stream.

FIG. 2 illustrates the integration of the SMB, polishing bed, and two VCD units for removing the eluent from the extract or product stream and from the raffinate stream.

FIG. 3 illustrates the configuration of FIG. 1 further illustrating the thermal integration and recuperative heat exchangers.

FIG. 4 illustrates the configuration of FIG. 2 further illustrating the thermal integration and recuperative heat exchangers.

FIG. 5 illustrates a typical SMB system illustrating the inlet valve manifold assembly, the resin beds, and the outlet valve manifold assembly.

FIG. 6 is a graph of the solubility of sodium sulfate in glycerin-water showing representative operating points of an SMB separation.

FIG. 7 is a graph of glycerin purity versus glycerin loss from operation of an SMB system.

### DETAILED DESCRIPTION OF THE PREFERRED EMBODIMENT

The following description and examples illustrate some exemplary embodiments of the disclosed invention in detail. Those skilled in the art will recognize that there are numerous variations and modifications of this invention that are encompassed by its scope. Accordingly, the description of a certain exemplary embodiment should not be deemed to limit the scope of the present invention.

A family of methods and apparatus known as “distillation” can provide approaches for separating components with differing boiling points or vapor pressures. Some forms of distillation and distillation columns have been in common use for many years. A family of methods and apparatus known as “chromatography” provide approaches for separating liquid and gaseous materials which sometimes can be difficult to separate by distillation. Chromatographic separations can be used in laboratory investigations and in some industrial applications.

A more specialized family of distillation is vapor compression distillation (VCD), which is a specific class of distillation in which the vaporized component is compressed to effect the condensation of the vaporized component at a temperature greater than the temperature of vaporization. The positive temperature differential between the condensing and vaporizing fluids facilitates increased recycling of the heat in the vaporized phase back to the vaporizing liquid. VCD systems can be effective, especially in applications where there is a large difference between the boiling points of the components to be separated. VCD systems can be used in high capacity applications such as desalination, but accumulation of solids on the heat exchange surfaces can be problematic and can limit effective utilization of these techniques. Various approaches for avoiding the problems of scale formation have been attempted.

In U.S. Pat. No. 4,260,461, the feed material is acidified and degassed prior to processing to prevent carbonate deposits. In U.S. Pat. No. 4,539,076, problems of scaling are ignored and left for others to resolve for making a practical system. Use of each of these is limited to very specialized applications, such as where only carbonates present problems and where the conditions of pH, degassing, and processing time can be tolerated, without undue degradation of desirable compounds.

Other difficulties that can arise in a distillation operation relate to the potential for degradation or decomposition of desirable compounds due to the high temperatures present during processing. Operation at lower pressures can in some cases result in improvements, but frequently requires greater equipment size or multiple stages, adding expense and complexity with only a small change in the degree of degradation observed.

A more specialized family of chromatography is simulated moving bed (SMB) chromatography, which consists of two or more separation zones connected by a complex valve array. Each zone includes a bed or fraction of a bed containing a solid adsorbent phase (stationary phase) which is contained between a supply and withdrawal point. In many cases, zones of four, five, six, and more are used. Typically, one feed (F) stream of components to be isolated and at least one eluent (E) stream of solvent are passed into the SMB system, while at least one raffinate (R) stream and at least one extract (X) stream are withdrawn. In some cases a recycle loop is used, consisting of E or extract-rich eluent (EX). An SMB can operate by passing a feed stream comprising, for example, components A and B over a solid adsorbent phase which shows a higher affinity for component A than component B. The eluent stream is passed over the feed stream, pushing component B forward at a rate faster than component A and effecting separation of components A and B. By switching the zones in counter-flow direction to the eluent flow, component B can be removed downstream and component A can be removed upstream of the feed point.

SMB equipment can be used in many applications including specialty and high value, low volume applications. Other uses include separation of glucose and fructose in the food industry, and potentially the separation of glucose and xylose from biomass hydrolysate as an element of the evolving cellulosic ethanol industry.

### Description of Vapor Compression Distillation

Vapor compression distillation can be used on various process streams to separate components. In some cases, use of vapor compression distillation can lead to reduced energy consumption when compared to various other forms of distillation.

Vapor compression distillation includes distillation systems that compress a vapor stream from a distillation column, such as a distillation overhead stream, and then exchange the heat from the compressed stream to another stream, such as a feed stream to the distillation system or to a stream within the distillation system, such as in a reboiler. The vapor can be compressed to the point where it forms a condensate, or not. In some embodiments, the compression can result in a portion of the vapor condensing and a portion not condensing. The amount of compression that is applied can vary based on the composition of the streams present and the results desired. In some embodiments, the degree of compression can be selected to result in the condensation temperature of the compressed stream being higher than the desired temperature of the stream that the heat is transferred to. In some embodiments, only a portion of the heat that is needed for the particular stream that is being heated is supplied from the compressed stream. In some embodiments, all or nearly all of the heat is supplied by the compressed stream. In some embodiments, the compressed stream can exchange heat with more than one other stream, such as in a reboiler and with a process feed to the distillation system. When the compressed stream is exchanged with more than one other stream, the compressed stream can exchange heat with both other streams simultaneously (such as by dividing the flow of compressed vapor to the two different streams), sequentially (such as by having the compressed stream exchange heat with one stream and then another), or some combination of simultaneously and sequentially. In some embodiments, additional heat can be added from steam, combustion, electricity, or some other source of heat to the stream receiving heat from the compressed stream.

The distillation portion of a VCD system can include a plate column, a packed column, a flash tank, centrifugal distillation unit, thin film distillation unit, molecular distillation unit, vacuum distillation unit (operating under any appropriate level of vacuum), pressure distillation units, or some other unit for separation of a gas and liquid phase, or combination of these units. The distillation can operate with one theoretical plate, more than one theoretical plate, or less than one theoretical plate. In some embodiments, the distillation portion of the system can be divided into several parts, such as where several columns, flash tanks, or other distillation units are connected in series or in parallel.

Additional information on design and implementation of vapor compression distillation in particular situations, such as with nonscale-forming processes and high carbonate sea water can be found in U.S. Pat. No. 4,539,076 and U.S. Pat. No. 4,260,461, respectively, incorporated herein by reference in their entireties.

Difficulties in implementing vapor compression to distillation can arise, especially in achieving significant energy savings, when a process stream with a tendency to form scale, precipitates, or other solids (collectively “scale”) is used. When the solids precipitate, they can deposit on heat exchange services and reduce the ability to transfer heat between a stream exiting the still (such as distillate, raffinate, or still bottoms) and another stream such as a feed to the still.

Scale or precipitate formation in a vapor compression distillation system might be avoided in some cases by removing only a portion of the solubilizing component from the feedstream, with the resulting increased losses from such an approach. Addition of a solvent to the scaling-prone stream to prevent scale formation can decrease the thermal efficiency by adding another material which must be heated or, in the alternative by cooling the hot stream prior to heat transfer.

Propensity for precipitate formation and scale formation of a distillation feedstream can be determined by heating a filtered (for example, filtered through filter paper or other suitable medium) sample of distillation feedstream with stirring (under pressure if necessary) and at a heating rate of about 0.2-15° C. per minute. When the bulk temperature of the distillation feedstream reaches the temperature for which precipitate formation is being evaluated, a sample is withdrawn, cooled, and examined visually or otherwise for precipitate formation or other changes associated with scale/precipitate formation.

### Description of Simulated Moving Bed Chromatography

In some embodiments, problems associated with scale formation and the resulting inefficiencies in vapor compression distillation can be addressed by pre-treating the feed material in an SMB operation to modify the scaling tendency of the feed material. In some embodiments, at least a portion of one or more of the scaling substances can be removed. In some embodiments, at least a portion of one or more of the scaling substances can be replaced with a substance that is volatile. In some embodiments, the volatile substance can have a lower boiling point or higher vapor pressure than the non-scaling material in the feed. In some embodiments, a mobile phase of an SMB system can comprise the volatile substance. In some embodiments, a mobile phase of an SMB system can be primarily composed of the volatile material.

### General Principles

Simulated moving bed chromatography (SMB) is a continuous form of chromatography which includes forms of chromatographic separation or other adsorptive processes where, for example, through a valving arrangement, movement of solid phase in a direction opposite of a mobile phase is simulated or accomplished during processing. Frequently, such systems allow for continuous feed streams to be used with resulting continuous outlet streams. General information on the design and operation of simulated moving bed chromatography systems can be found in U.S. Pat. No. 7,141,172, incorporated herein by reference in its entirety.

Separation generally occurs through some species in a feed having greater affinity for a stationary phase than other species in the environment within the columns or beds of the system. The environment can refer to such things as the concentration of various species present, mobile phase/solvent composition, temperature, pressure, etc. In a conventional (non-SMB) chromatography system, species with lower affinity for the stationary phase tend to move more quickly through the system. Species with a stronger affinity for the stationary phase tend to move more slowly through the system. In a SMB chromatography system, the slower species will tend to move in one direction (the direction of stationary phase flow), and the faster species will tend to move in the other direction (the direction of mobile phase flow).

The adsorption that takes place in this form of chromatography can include forms of adsorption related to hydrogen bonding, ionic bonding, chemical bonding, Van der Waal's binding, etc. Additional phenomena that can influence a separation include such things as diffusion of species into the stationary phase. Diffusion can be affected by such things as pore size, chemical composition of the stationary phase and liquid environment, temperature, pressure, flow rate, size of stationary phase particles, size of the diffusing species, and other factors that affect mass transport.

Frequently, an SMB system is described pictorially as a series of beds with the outlet of one connected to the inlet of the next in the direction of flow of the mobile phase. Frequently, the mobile phase flows from left to right and the simulated movement of the beds is from right to left. During a valve switch to simulate the movement of the beds, the leftmost bed is moved into the rightmost position. Eventually, each bed moves through the region where the more poorly adsorbed species is removed from the system. As a result, it is possible for the species more strongly absorbed to the stationary phase to be desorbed at the wrong time, and being unduly present in the stream intended to be depleted of the more strongly adsorbed species.

Selection of a mobile phase with appropriate solvation power or affinity for the particular species being separated can be an important aspect of the design of an SMB system, as can be the selection of appropriate stationary phase and flow rates and timing of bed movement. Less than ideal selection of one or more of these parameters can lead to undue fouling of the stationary phase, inadequate separation, high product losses, etc.

In some embodiments, the mobile phase can be utilized as a stream that passes from one bed to the next through the series of beds, and is recycled back to the first bed after exiting the last in the line. A portion of the mobile phase can be removed with each product, with makeup material added with the feed, or as a separate point in the process. In some embodiments, mobile phase can be added at more than one point.

In some embodiments, the mobile phase can be recycled to a point different from the first bed, with a second mobile phase used in the beds to the left of the bed where first mobile phase is recycled to. In some embodiments, where two or more mobile phases are used, the composition of each mobile phase can be the same or different. In some embodiments with two or more mobile phases, the material for the first mobile phase can be the same as the second mobile phase. In some embodiments where two mobile phases are present, the second mobile phase can act as a bridge step for the beds which it contacts, with the mobile phase flowing into the bed that the first mobile phase is recycled to. In some embodiments, the second mobile phase can flow into the bed receiving the recycled first mobile phase. In some embodiments, only a portion of the second mobile phase flows into the bed receiving the recycled first mobile phase. In some embodiments, one product is recovered from a first mobile phase, and another product is recovered from the second mobile phase. In some embodiments, the bed or beds treated with the second mobile phase are drained or purged prior to moving the bed to its next position.

In some embodiments, it is desirable to select a mobile phase having a lower boiling point than a temperature that can lead to precipitation of components in the feedstream to a distillation or vapor compression distillation system downstream of the SMB. In some embodiments it is desirable to select a mobile phase having a lower boiling point than the temperature where a component of the feed is altered physically or chemically. Physical or chemical altering includes any change that affects the separation or products. Physical or chemical alteration can include decomposition, polymerization, depolymerization, side reactions, chemical rearrangement of bonds, isomerization, refolding of proteins, changes in conformation, rearrangement of hydrogen bonds, precipitation, etc., and can be reversed upon cooling, not reversed upon cooling, or only partially reversed upon cooling. In some embodiments, the temperature where physical or chemical alteration occurs can be present in a distillation or vapor compression distillation system. In some embodiments, a mobile phase with a lower boiling point can allow for more favorable operation in a distillation (including vapor compression distillation) subsystem by modifying the separation that occurs in the distillation subsystem. For example, vaporization of the mobile phase present in the distillation feed can replace vaporization of a higher boiling component. This change can lead to lower scaling or precipitation tendencies within the equipment, resulting in improved heat transfer, especially over a sustained period, by operating at a lower temperature or by reducing the concentration of precipitating material in relation to the material being recovered from the feed. This change can also lead to reduced decomposition or chemical modification of components in the feed by allowing operation at a lower temperature than would normally occur. These changes can in turn facilitate additional improvements to a separation, such as allowing distillation under pressure rather than under vacuum and separation with a greater number of theoretical plates and/or higher throughputs.

### Combined Vapor Compression Distillation and SMB Treatment

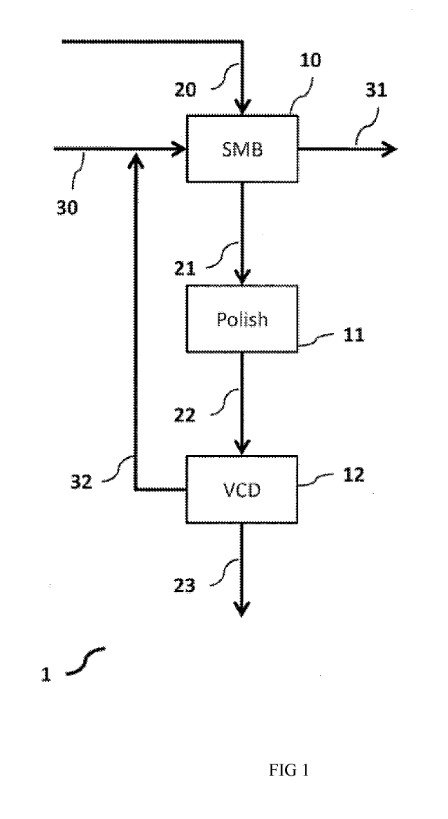

In FIG. 1, a high efficiency separation method 1 is shown which includes a simulated moving bed (SMB) 10 unit, an optional ionic polishing unit 11, and a vapor compression distillation (VCD) unit 12. A stream 20 that consists of a mixture of feed components A and B, both of which are soluble in eluent solvent 30, are fed to the SMB 10 to effect the separation of A from B by passing an eluent solvent 30 through the mixture in contact with the solid adsorbent in the columns of the SMB. The solid adsorbent in the columns can be selected from a variety of adsorbents which demonstrate an increased affinity for one compound over the other. For purposes of this discussion, we will assume that component A has a higher affinity for the solid adsorbent than component B. The discussion or selection of any specific solid adsorbent and the discussion or selection of any specific mixture of compounds A and B are not intended to limit the scope of this invention, but are provided as illustrative examples.

As the feed 20 passes over the solid adsorbent, component A demonstrates a greater affinity to the resin than compound B. The eluent solvent 30 passes through the feed mixture pushing both compounds downstream, but effectively component B has a greater eluting speed through the column than compound A because component B has a lower affinity for the solid adsorbent. The valve timing responsible for the simulated motion of the columns is adjusted with respect to mixture feed flow rates, the eluent flow rates, and the relative affinity of components A and B to the solid adsorbent. The result is a raffinate stream 31 primarily composed of eluent and component B with only reduced amounts of compound A and an extract stream 21 primarily composed of eluent and component A with only trace amounts of component B. In this embodiment, the extract stream is the primary product stream targeted for high purity, but in other embodiments either stream (or even both) could be the product stream, with one or both optionally treated to increase purity beyond that achieved with the SMB system alone, depending on the separation of interest. In some embodiments one of the components, such as a component B, can be a waste product.

The extract stream 21 is passed to an optional polishing bed 11 in which the amount of component B is further reduced to, for example, meet the final purity target. The outlet of the polishing unit 11 is dilute product stream 22 which is passed to a VCD unit 12. The function of the VCD is to separate the eluent solvent from the product component A. The eluent is evaporated and condensed in the VCD to produce eluent stream 32 which is optionally recycled back into the SMB unit 10. The high purity, high concentration product stream of component A is passed out of the VCD as product stream 23.

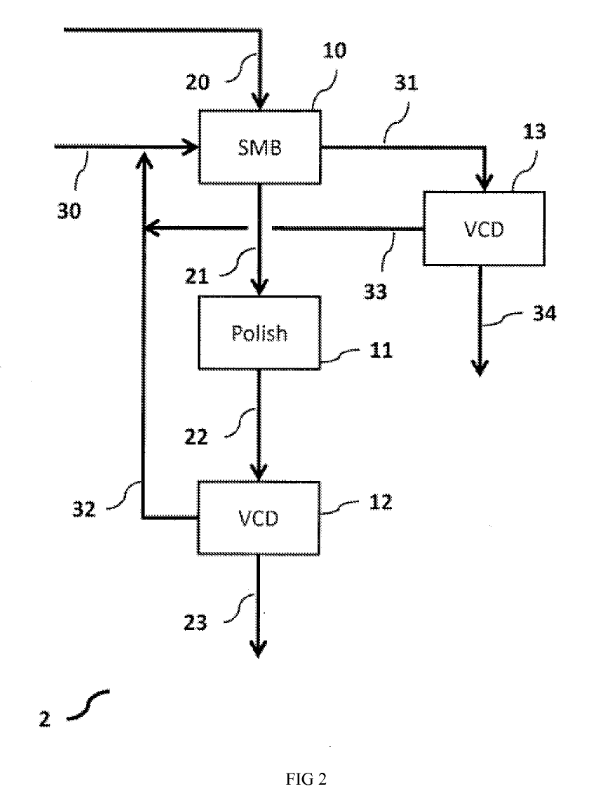

In some embodiments, an optional separation system can be utilized to concentrate component B in the raffinate stream 31. Various separation systems can be utilized including evaporators, filters, microfilters, ultrafilters, cross-flow filters, nanofilters, distillation, extraction, adsorption, absorption, vapor compression distillation, etc. In FIG. 2, a system utilizing a second VCD system 13 is incorporated into the processes to enhance the eluent recovery and maximize the concentration of component B in the concentrated raffinate stream 34. This VCD unit vaporizes and condenses the eluent from stream 31 to generate recycle stream 33. The energy required for the vaporization of the eluent is recycled within the VCD unit to minimize energy consumption and maximize process efficiency. In some embodiments, the mass recovery of eluent from a raffinate stream 31 can be more than about 30%, or more than about 50%, or more than about 70%, or more than about 90% of the eluent in the raffinate stream 31 before the concentration of component B in the waste stream begins to reach its saturation point. In some embodiments, separation systems other than vapor compression distillation can be utilized which can facilitate recoveries beyond the point where saturation can occur.

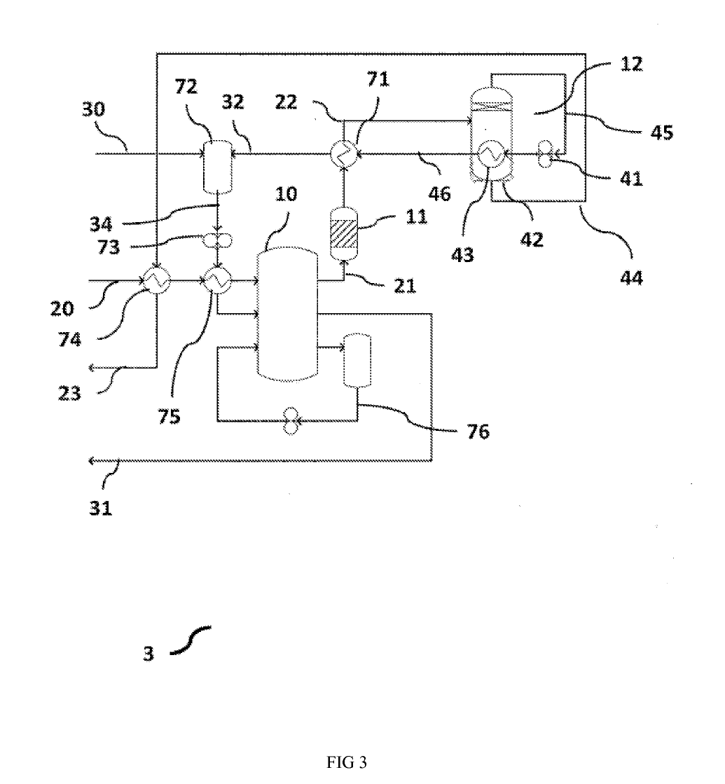

In some embodiments, an energy recycling scheme can be implemented, such as is shown in FIG. 3, which illustrates an embodiment of heat exchanger integration for a combined SMB-VCD system, which can optionally include heating the material fed to the SMB. FIG. 3 illustrates expanded details of a VCD unit 12, consisting of a vapor compressor 41, heat exchanger 43, evaporation/distillation vessel 42. The extract stream 21 passes through the polishing unit 11 and flows through recuperative heat exchanger 71 and enters the vapor compression unit 12 through connection 22. A boost heater can be used to increase the temperature of stream 22 as it enters the vessel 42 where the lower boiling eluent fluid is vaporized and the higher boiling product compounds remain in liquid phase. The eluent vapor passes through connection 45 and enters compressor 41 where the pressure is increased to a level sufficient to cause the vapor to condense in heat exchangers 43 and 71. The heat of condensation is transferred into the liquid mixture in vessel 42 and into incoming stream 22 at heat exchanger 71, where the energy is balanced by the energy needed for vaporizing the eluent fluid. In some embodiments, the fluid in vessel 42 is recycled within the vapor compressor unit (pump not shown) to ensure high efficiency heat transfer and high degree of eluent removal. In this configuration of heat exchangers, the concentrated product stream 44 passes out of the vapor compression unit 12 through connection 44 where it enters heat exchanger 74 and helps to preheat feed mixture stream 20, when desired; stream 44 then exits the system through connection 23. The recovered eluent exits heat exchanger 71, passes through connection 32 and into buffer tank 72, where it is combined with feed eluent stream 30. The eluent is then pumped by pump 73 through heat exchanger 75 and into the SMB unit 10. Also illustrated in this embodiment is the option of having an eluent recycle loop 76.

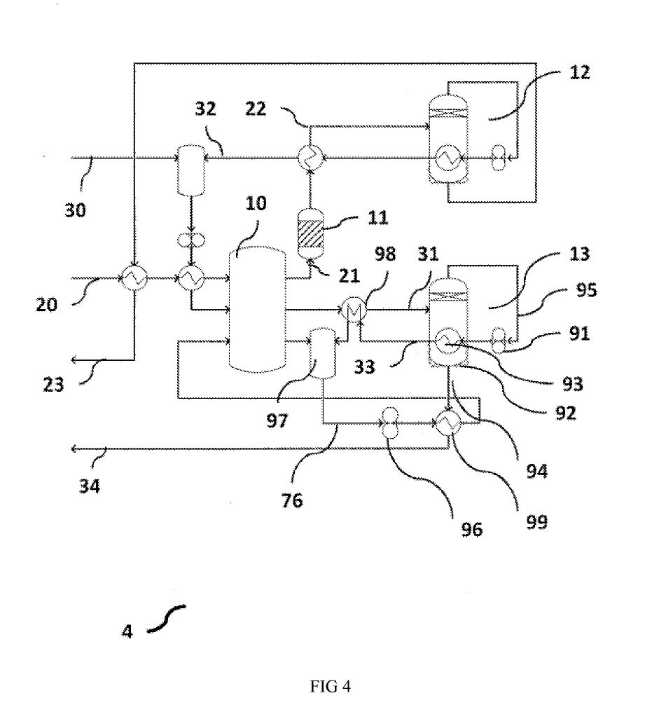

In some embodiments, an energy recycling scheme can be implemented, such as with evaporative concentration/distillation, on both the extract and raffinate streams from an SMB, as shown in FIG. 4, which illustrates an embodiment of heat exchanger integration for a combined SMB-VCD system, where VCD is present on two outlet streams from an SMB. FIG. 4 illustrates a heat exchanger interface for the embodiment shown in FIG. 2 that incorporates a second VCD unit to support the recovery of eluent solvent from the raffinate stream 31. In this embodiment a VCD unit 13 is shown indicating raffinate stream 31 flowing into the evaporative/distillation vessel 92 where some of the vaporized eluent flows through connection 95 to compressor 91. The compressor increases the pressure of the vapor, causing condensation of the eluent and in heat exchanger 93 which transfers energy into the liquid in the vessel 92 or into the raffinate stream 31 by way of heat exchanger 98. The condensed eluent solvent is collected in buffer tank 97 and pumped through heat exchanger 99 and back into the SMB 10 as a recycle eluent stream.

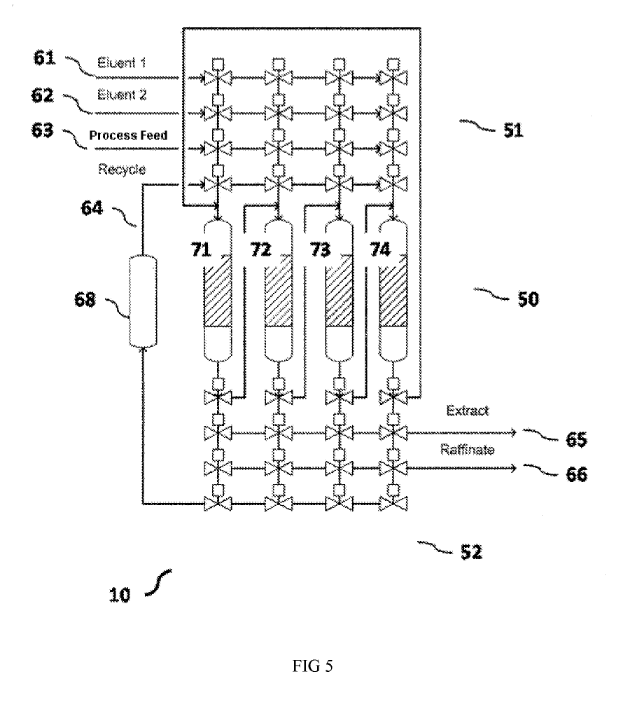

One embodiment of an SMB unit 50 is shown schematically in FIG. 5, with four chromatography columns: 71, 72, 73, and 74, and two valve manifold blocks: inlet block 51 and outlet block 52. Other configurations of the SMB unit 10 are viable with greater number of columns such as five, six, seven, eight, or more, and even with fewer columns depending on the SMB process used. Likewise, other valving or manifolding arrangements can be utilized, such as rotating valve assembles, multi-way valves, or other types of valves as well as shared or dedicated pipes/manifolds/headers/ducts. This illustration is provided only to describe a representative SMB and is not intended to limit the scope or definition of the method.

In one embodiment, an SMB system as in FIG. 5 can be divided into a three zone SMB, but in various other embodiments, other numbers of zones can be utilized. Three feed streams—eluent one 61, eluent two 62, and process feed 63—and one recycle stream 64 are provided to the inlet manifold block 51. Two product streams, extract 65 and raffinate 66, the recycle stream 64, and the column-to-column bypass streams are managed by the outlet manifold 52. The following discussion is for a three zone SMB where column 71 represents the first zone, column 72 represents the second zone, and columns 73 & 74 represent the third zone. During operation, process feed 63 passes through manifold block 51 and enters column 73, while eluent one 61 enters and passes to column 71 and eluent two 62 enters and passes to column 72. Fluid from column 71 exits through outlet manifold block 52 and passes out through extract 65. Fluid from column 72 exits through block 52 and is transferred to the inlet of column 73 along with process feed 63. Fluid from column 73 exits through block 52 and is transferred to the inlet of column 74, while the fluid passing through column 74 exits through block 52 and passes out through raffinate 66. Once steady state is achieved, column 71 contains adsorbed component A and very little component B at the beginning of the switching cycle; columns 72 and 73 contain a mixture of components A & B; and column 74 contains eluent solvent. Eluent one 61 pushes the adsorbed component A out of column 71 and out through the extract 65. Eluent two 62 pushes the mixture of components A and B in column 72 out and into column 73, while mixing with process feed 63 at the inlet of column 73. Eluent two 62 continues to push compound B downstream and eventually out of column 74 and into the raffinate 66. After all of component A is removed from column 71 and before component A is pushed out column 74 with the raffinate 66, the valves in manifolds 51 and 52 are switched, effectively moving the columns one position to the right, such that column 72 is moved into the first zone, column 73 is moved into the second zone, and columns 74 and 71 are moved into the first and second positions, respectively, of zone three. This switching effectively moves component A upstream while component B continues to move downstream, promoting the separation of the components.

In various other embodiments, other arrangements of an SMB system can be utilized and can be operated in different ways, such as by varying the number of columns; introducing the process feed at a different point; introducing eluent at a different point; removing extract and/or raffinate at a different point; and recycling, purifying, or otherwise modifying eluent utilized in the system.

Separation of Glycerin from Salt or Base

In one embodiment, a separation of glycerin from a salt or a base can be accomplished with vapor compression distillation with reduced tendency for scale formation and/or reduction in thermal efficiency over time by treating the contaminated glycerin stream in an SMB operation to replace the salt or base with a lower boiling component, such as water, prior to treatment in the vapor compression distillation unit.

### Example 1

### Desalting of Glycerin

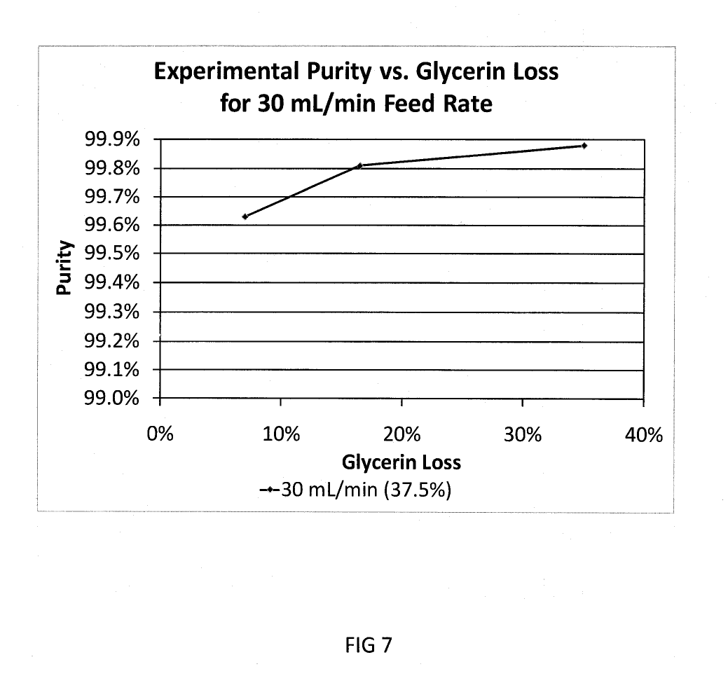

A combination of VCD and SMB can be used to separate glycerin from a soluble salt. A laboratory prototype unit was designed and operated on glycerin contaminated with 2.5% sodium sulfate salt. The eluent solvent was de-ionized water. The unit consisted of four columns arranged as a three-zone SMB with inlet and exit solenoid valves assemblies. An ionic exclusion resin was selected because of its higher affinity to the glycerin than the ionic salt compounds. The columns were packed with 78 gm of the neutral form of a strong acid cation resin, LEWATIT® GF-404 resin (Lanxess, Leverkusen, Germany). Each column was 25 cm long with an inside diameter of 2.1 cm. Eluent solvent flow rates between 20 and 100 ml/minute were introduced at the inlet of zone 1 (1 column) to recover the purified glycerin, with all of the eluent collected after passing through the column. Eluent solvent flow rates between 20 and 100 ml/minute were introduced at the inlet of zone 2 (1 column) to flush the salt downstream. The material from zone 2 flowed to zone 3. Feed glycerin solution flow rates between 20 and 70 ml/minute were introduced at the inlet of zone 3 (2 columns). The switch time was varied between 30 and 60 seconds, depending on the various flow rates. Preliminary performance map of the glycerin SMB unit is illustrated in FIG. 7. A typical operating point indicates the ability to achieve 99.8% glycerin purity with 83% recovery. The glycerin extract stream was recovered as a 25% (wt.) solution in water, and the salty raffinate stream was recovered as a stream having 0.7% (wt.) salt and 2% (wt.) glycerin in water. Since the boiling point of water is substantially lower than the boiling point of glycerin, the water can be evaporated at a higher pressure and could be used to evaporate glycerin without undue alteration of the glycerin to achieve a high concentration glycerin product stream. The energy required to convert a 25% (wt.) glycerin stream to a near 100% (wt.) glycerin stream by evaporating the water would require approximately 2,100 kilocalories/liter of glycerin. This amount of energy is approximately equivalent to 7 times the heat of vaporization of glycerin, which can be less efficient than a two-stage distillation unit.

Glycerin from Biodiesel Production

The production of biodiesel is frequently conducted in modular refineries, from micro-scale batch reactors (100 to 400 liters per batch) to small-scale continuous processes (1,000 to 4,000 liters per hour). Site-constructed facilities typically range from 4,000 liters per hour (10 M gallons/year) to 50,000 liters per hour (100 M gallons/year). With a typical continuous modular biodiesel production system (39 M liters per year or 10 M gallons per year) the unit consumes 4,113 kg/hr of vegetable oil, 588 kg/hr of methanol, 25 kg/hr of catalyst (NaOH), and produces 4,087 kg/hr of biodiesel, 632 kg/hr of g-phase (glycerin, catalyst, soaps, and methanol), and 7 kg/hr of waste. The glycerin-phase is treated to remove the methanol and soaps while neutralizing the catalyst with about 10% H₂SO₄ solution to produce a crude glycerin solution consisting of 408 kg/hr of glycerin, 33 kg/hr of Na₂SO₄ and 208 kg/hr of water or crude glycerin solution with a composition of about 63% glycerin, about 5% salt and other contaminants, and about 32% water. Principles related to the separation of glycerin and salt or base can be applied to the crude glycerin side stream associated with biodiesel production.

### Example 2

### Separation of Catalysts/Salt from Glycerin Byproduct of Biodiesel Production

One application of this method is the separation of the homogeneous catalyst from the co-product glycerin produced in biodiesel facilities. Frequently, in a biodiesel facility, triglycerides are mixed with alcohol and sodium hydroxide and are reacted at elevated temperatures to form an alkyl-ester (biodiesel) and glycerin. A majority of the catalyst exits the reactor in the glycerin-phase (g-phase), which can be neutralized with an acid such as sulfuric acid to facilitate separation and recycle of non-reacted triglycerides. Often, the excess alcohol in the g-phase is also removed before or after neutralization.

In operation, the g-phase can be further contaminated with other components of the vegetable oil or animal fat feed material used as the source of triacylglycerides, such as chromophores, partial glycerides, fatty acids, sterols, stanols, gums, waxes, proteins, carbohydrates, phospholipids, lysophospholipids, etc. as well as derivatives of these materials and side products of the reaction forming the biodiesel material, such as non glycerin organic matter. The presence of additional impurities such as these can add to the complexity of designing a suitable separation system, especially one which utilizes simulated moving bed technology. Issues that can arise include fouling of the stationary phase, reaction with the stationary phase, as well as the need to force the additional impurities to the exit point of the process desired. For example, selection of a stationary phase that adsorbed the impurities too strongly can result in the impurities remaining with the glycerin instead of the salts. Alternatively, if the impurities do not adhere strongly enough, they can move through the beds to quickly, and not be removed with the salts, but instead be recycled, potentially building up and fouling the system and/or contaminating the glycerin stream. In addition, each of these impurities can have different adsorption and solvation properties, resulting in the need to balance the stationary phase selection and the eluent composition.

In some embodiments, a system such as that described herein for the separation of salt from glycerin can be used with little modification. In some embodiments, an additional zone can be utilized for removal of organic contaminants with a suitable solvent as an eluent, such as an alcohol, an aldehyde, a ketone, a nitrile, a hydrocarbon, an aromatic, a halogenated compound, etc., in, for example, a step which isolates this eluent from the other eluent being used. In some embodiments, the conditions or composition of one of the eluents already incorporated into the system can be modified, such as by increasing or decreasing the polarity or dipole moment of the solvent. In some embodiments, increasing the salt concentration (such as by decreasing the amount of eluent, recycling raffinate, or adding salts) can result in shifting the adsorption and passage rate for various impurities, allowing them to be captured with the salts. In some embodiments, higher levels of eluent can be used to reduce the salt concentration, and shift the absorption characteristics of the impurities.

In some embodiments, the feed to the SMB can be further processed to remove particular impurities. Suitable methods of treatment include filtration, microfiltration, ultrafiltration, adsorption, extraction, absorption, etc. In some embodiments, highly nonpolar materials can be removed prior to treatment in the SMB operation.

### Example 3

### Purification of Glycerin Byproduct from Biodiesel Production by Distillation

A feedstream stream of glycerin and sodium sulfate can be separated in a two-stage vacuum distillation process. Glycerin (C₃H₈O₃) has a molecular weight of 92.1 g/mole, a boiling point of 290° C. (554F), a heat capacity of 0.62 cal/g at 25° C., a heat of vaporization of 21,060 cal/mole at 55° C., a specific gravity of 1.262 at 25° C., and a vapor pressure of 0.195 mmHg at 100° C. Some industrial scale two-stage vacuum distillation systems (non-vapor compression distillation systems) can process approximately 7.6 million liters per year (about 2 million gallons per year or 2,234 lb/hr glycerin product), with approximately 80% recovery of the feed glycerin, and requiring about 1,266 kilocalories/liter (19,000 Btu/gallon) based on the glycerin product. This energy consumption is equivalent to approximately 4 times the heat of vaporization of glycerin.

Some industrial process uses a two-stage vacuum distillation method. A unit designed for approximately 7.6 million liters per year (2 million gallons per year or 2,234 lb/hr glycerin product), achieves approximately 80% recovery of the feed glycerin, and requires 1,266 kilocalories/liter (19,000 Btu/gallon) based on the glycerin product. This is equivalent to 4 times the heat of vaporization of glycerin. Vapor compression distillation is not used.

### Example 4

### Concentration of Purified Glycerin

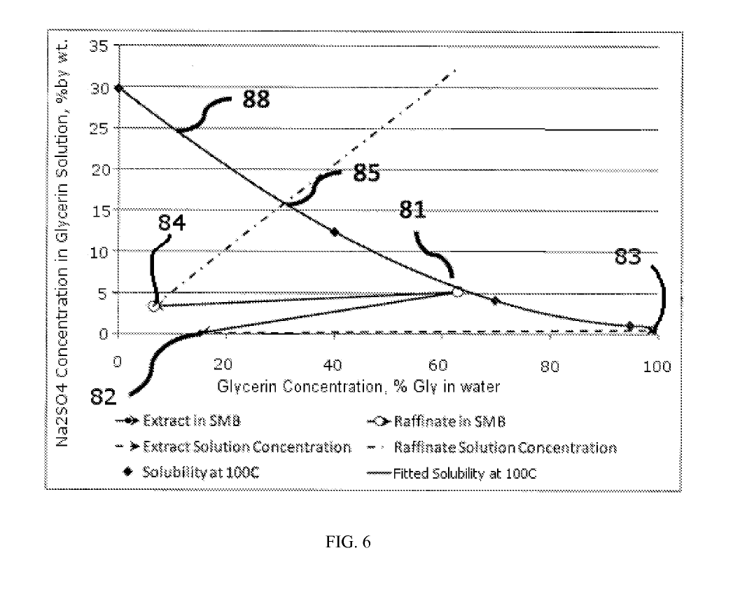

By integrating an SMB unit with a VCD, unit a much higher efficiency and lower carbon footprint process can be achieved. In embodiments where the product from the SMB prototype unit is concentrated with a VCD unit, the estimated energy required can be about 160 kilocalories per liter of glycerin. This is equivalent to about 0.5 times the heat of vaporization of glycerin, which is about ⅛ the heat requirement for an industrial two-stage vacuum distillation process and about one 1/13 the heat requirement for an SMB process with conventional distillation of water eluent from the glycerin. As shown in FIG. 1 and FIG. 6, the crude glycerin feed can be represented by composition 81. During the SMB 10 processing step, two product streams are generated. The salt is concentrated into a raffinate stream 31, which exits the SMB at a composition 84, while the glycerin is concentrated into an extract stream 21, which exits the SMB at a composition 82. In one embodiment the extract stream is then concentrated by removal of water with a VCD 12 effectively reaching composition 83 without a significant reduction in the amount of heat in the distillation vapor stream being lost. Recovered water can be passed back to the SMB 10 through connection 32. In some embodiments, an optional polishing bed 11 can be used if higher purity glycerin is the target product. Suitable polishing beds include activated carbon, the ionization resin, neutral adsorbents (polymeric, zeolites, silicas, etc.).

### Example 5

### Concentration of Salt Stream by Vapor Compression Distillation

In another embodiment, as shown in FIG. 2 and FIG. 6, a portion of the water content of the raffinate stream can also be recovered with minimum energy input. A second VCD 13 is used to move the raffinate composition 84 to composition 85, before the salt begins to reach its maximum concentration. At this point approximately 90% of the water in the raffinate stream has been recovered.

In FIG. 6, the feed composition 81 is very close to the solubility curve for salt in the glycerin-water mixture. This characteristic indicates that if a VCD process were used in either the removal of water from the feed material or the direct distillation of glycerin, salt would precipitate out of solution because the composition would be above the solubility line 88. This salt precipitate could coat the heat exchanger surface area and decrease the effectiveness of the VCD equipment by, for example, decreasing heat transfer efficiency, demonstrating a benefit of a combined SMB and VCD system.

### Application to Temperature Sensitive Materials

The principles of combined vapor compression distillation and simulated moving bed processing, as described herein, can be applied to recovery of temperature sensitive products. In one embodiment, the use of water as a mobile phase in the recovery of glycerin from a stream comprising salt or base allows distillation of a stream comprising glycerin at a lower temperature without resorting to conditions of high vacuum or suffering undue product decomposition by evaporating lower boiling water instead of higher boiling glycerin. Other mobile phases can also be applied to this type of separation, such as alcohols, carbonyl compounds, hydrocarbons, etc. In other embodiments, the use of combined vapor compression distillation and simulated moving bed processing can be applied to other temperature-sensitive products, such as oils (including oils having highly unsaturated fatty acids) and other components of vegetable oils such as sterols, stanols, tocotrienols, etc.

### Example 6

### Separation of Free Fatty Acids from Crude Vegetable Oil

Another application of this method is the separation of free-fatty acids from triglycerides present in the mixture of off-specification crude corn oil extracted from the thin stillage of corn ethanol facility. Typically, this extracted oil is composed of 80-90% triglycerides, 10-20% free-fatty acids and 0-5% waxes or other compounds. A resin can be selected which has a stronger affinity to the free-fatty acids because of their polar nature or smaller molecular weight. In this example the free-fatty acids are compound A while the triglycerides are compound B. The eluent solvent can be selected from any of a series of organic solvents such as alcohols (methanol, ethanol, 1-propanol, 2-propanol, 1-butanol, 2-butanol, 2-methyl-1-propanol, pentanols, hexanols, etc.), carbonyl-containing compounds (aldehydes, ketones, acetone, 2-propanone, 2-butanone, etc.), nitriles, alkanes, aromatic solvents, halogenated organics, etc.,

All references cited herein, including but not limited to published and unpublished applications, patents, and literature references are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification are to be understood as being modified in all instances by the term “about.” Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention.

What is claimed is:

1. A process for separation and purification of compounds in a liquid mixture with low energy input, the process comprising:
passing a feed mixture comprising a first compound and a second compound into a simulated moving bed chromatography apparatus;
the first compound acting as a solvent for the second compound which forms a precipitate at concentrations above a solubility limit;
passing an eluent solvent into the simulated moving bed chromatography apparatus to separate the feed into a first stream and a second stream, wherein the first stream has an elevated concentration of the first compound in eluent and the second stream has an elevated concentration of the second compound in eluent, as compared to the feed;
passing the first stream to a vapor compression distillation unit to generate a high purity stream of the first compound;
vaporizing at least a portion of the eluent from the first stream at a first temperature to form a vapor, compressing the vapor to form an eluent condensate at a second temperature, such that the second temperature is greater than the first temperature, and the eluent condensate has a thermal energy content; and
transferring at least a portion of the thermal energy content of the eluent condensate into the first stream to be used in vaporizing the eluent in the first stream.

2. The process of claim 1, wherein less thermal energy is added to the process than would be needed to vaporize the high purity stream of the first compound.

3. The process of claim 1 further comprising:
passing the second stream to a vapor compression distillation unit to recover additional eluent and to generate a concentrated second stream with less eluent.

4. A process for separation and purification of compounds in a liquid mixture with low energy input, the process comprising:
passing a feed mixture comprising a third compound and a fourth compound into a simulated moving bed chromatograph apparatus at a process temperature, the third compound and the fourth compound being liquids at the process temperature, at least one of the third and fourth compound being chemically or physically changed at a third temperature, the third temperature being greater than the process temperature and lower than a fourth temperature, the fourth temperature being the boiling point of the lower boiling of the third compound and the fourth compound;
passing an eluent solvent into the simulated moving bed chromatography apparatus to facilitate separation of the compounds into a third stream and a fourth stream, such that the third stream has an elevated concentration of the third compound in eluent and the fourth stream has an elevated concentration of the fourth compound;
passing the third stream to a vapor compression distillation unit to generate a high purity stream of the third compound;
vaporizing the eluent from the third stream at a first temperature, compressing the vapor to form an eluent condensate at a second temperature such that the second temperature is greater than the first temperature, and the eluent condensate has a thermal energy content; and
transferring at least a portion of the thermal energy content of the eluent condensate into the third stream to be used in vaporizing the eluent in the third stream.

5. The process of claim 4, wherein less thermal energy is added to the process than would be needed to vaporize the high purity stream of the third compound.

6. The process of claim 4 further comprising:
passing the fourth stream to a vapor compression distillation unit to recover additional eluent and to generate a concentrated fourth stream.

7. A system for separating two or more components from a process stream, the system comprising:
an SMB subsystem with a mobile phase, the SMB subsystem configured to convert a feed stream comprising a first component and a second component, wherein the first component and the second component are present in the feed stream at a first ratio defined by the weight percent of the second component divided by the weight percent of the first component, and the first component is a solvent for the second component, and the second component forms a precipitate at a concentration higher than a concentration present in the feed, into a first stream comprising at least a portion of the first component and at least a portion of the mobile phase, and a second stream comprising at least a portion of the second component and at least a portion of the mobile phase, wherein the first component and the second component are present in the first stream at a second ratio defined by the weight percent of the second component divided by the weight percent of the first component, wherein the first ratio is greater than the second ratio; and
a vapor compression distillation subsystem, operating on a distillation feed stream comprising at least a portion of the first stream to separate an amount of the first component from at least a portion of the mobile phase that is present in the first stream with evaporation, the evaporation requiring a thermal energy input, and the system for separating two or more components from a process stream having a total thermal energy input, wherein the distillation feed stream is subjected to a maximum bulk temperature and a maximum surface temperature during processing in the vapor compression distillation subsystem, the total thermal energy input to the system is less than the thermal energy required to evaporate the amount of first component separated in the vapor compression distillation subsystem, and the second component does not form a precipitate in the distillation feed stream at a temperature experienced by the portion of the first stream within the vapor compression distillation subsystem.

8. The system of claim 7, wherein the temperature experienced by the portion of the first stream is a bulk temperature.

9. The system of claim 7, wherein the temperature experienced by the portion of the first stream is the maximum bulk temperature.

10. The system of claim 7, wherein the temperature experienced by the portion of the first stream is a surface temperature.

11. The system of claim 7 wherein the temperature experienced by the portion of the first stream is the maximum surface temperature.

12. A system for separating two or more components from a process stream, the system comprising:
an SMB subsystem with a mobile phase, the SMB subsystem configured to convert a feed stream comprising a first component and a second component, wherein the first component and the second component are present in the feed stream at a first ratio defined by the weight percent of the second component divided by the weight percent of the first component, and at least one of the components is altered at a first temperature, the first temperature being lower than a temperature at which the other component is altered, and the alteration is not reversed completely upon cooling, into a first stream comprising at least a portion of the first component and at least a portion of the mobile phase, and a second stream comprising at least a portion of the second component and at least a portion of the mobile phase, wherein the first component and the second component are present in the first stream at a second ratio defined by the weight percent of the second component divided by the weight percent of the first component, wherein the first ratio is greater than the second ratio; and
a vapor compression distillation subsystem, operating on a distillation feed stream comprising at least a portion of the first stream to separate an amount of the first component from at least a portion of the mobile phase that is present in the first stream, the first component having a boiling point in its purified form at a second temperature at a pressure present within the distillation subsystem, the second component having a boiling point in its purified form at a third temperature at a pressure present within the distillation subsystem, a portion of the mobile phase present in the distillation feed stream having a boiling point at a fourth temperature at a pressure present within the distillation subsystem, the fourth temperature being lower than the first temperature and the first temperature being lower than both the second and third temperatures, the vapor compression distillation subsystem having a first thermal energy requirement to be supplied to produce a mass of the first component, and the first thermal energy requirement being less than an amount of thermal energy necessary to evaporate the mass of first component.
